(19) United States
(12) Patent Application Publication
(10) Pub. No.: US 2020/0043677 A1
(43) Pub. Date: Feb. 6, 2020

(54) Plunger Interface

(71) Applicant: Bose Corporation, Framingham, MA (US)

(72) Inventors: Daniel D. Gonsalves, Hudson, NH (US); Seth Mann, North Reading, MA (US); Allen T. Graff, Sutton, MA (US); Edgardo Alicea, Brockton, MA (US)

(21) Appl. No.: 16/050,015

(22) Filed: Jul. 31, 2018

(51) Int. Cl. H01H 13/06

(52) U.S. Cl. CPC H01H 13/06; H01H 13/52

(57) ABSTRACT

A structure for interfacing a plunger that is exposed outside of a housing and is constructed and arranged to be pushed in relative to the housing so as to operate a switch that is located inside of the housing. The structure has an elastic portion that is constructed and arranged to interface with the plunger so as to maintain the plunger in the housing and a stiff portion that is coupled to the elastic portion and is constructed and arranged to interface with the housing so as to capture the structure in the housing.

### BACKGROUND

This disclosure relates to a structure that interfaces a plunger to a housing.

A movable plunger can be used to operate a switch located within a housing. For example, headphones usually have at least one user-operable switch to control certain functions such as on-off and use mode. Some switches are operated by pushing in on an operating surface, where the operating surface automatically returns to its rest position when the pushing force is released. When this type of switch is located inside of a housing or other structure, a plunger can be used as the switch actuator. There needs to be some structure to hold the plunger in place and allow its in and out motion. If the plunger is exposed to the outside of the housing there needs to be an opening in the housing for the plunger. This opening can be an ingress point for dust, moisture and other contaminants, which can have a detrimental effect on operation of the device.

### SUMMARY

All examples and features mentioned below can be combined in any technically possible way.

In one aspect, a structure for interfacing a plunger that is exposed outside of a housing and is constructed and arranged to be pushed in relative to the housing so as to operate a switch that is located inside of the housing includes an elastic portion that is constructed and arranged to interface with the plunger so as to maintain the plunger in the housing, and a stiff portion that is coupled to the elastic portion and is constructed and arranged to interface with the housing so as to capture the structure in the housing.

Embodiments may include one of the following features, or any combination thereof. The plunger may comprise a recess, and the elastic portion may in part be located in the recess of the plunger. The recess may comprise a circumferential groove in the plunger and the elastic portion may comprise a ring that is seated in the groove. The structure may further include an adhesive substance at an interface between the ring and the groove. The housing may comprise a pocket, and the structure may be constructed and arranged to fit into the pocket. The pocket may define a sealing surface and the elastic portion may be face sealed against the sealing surface. The pocket may further define opposed sidewalls and the stiff portion may abut the sidewalls.

Embodiments may include one of the above and/or below features, or any combination thereof. The stiff portion may comprise a frame with a top face, an inner perimeter, and a depth. The elastic portion may comprise a face portion that overlies the top face of the frame, and an inner portion that abuts the inner perimeter of the frame and has a depth that is less than the depth of the frame. The inner perimeter of the frame may comprise a plurality of spaced grooves that are open to the top face of the frame and have a depth less than the depth of the frame, and the inner portion of the elastic portion may comprise an equal plurality of spaced projecting portions that fit into the spaced grooves of the frame. The face portion of the elastic portion may have a top face with edges that are chamfered. The inner portion of the elastic portion may define a bore and the plunger may pass through the bore. The inner portion of the elastic portion that defines the bore may comprise a chamfer that abuts the plunger.

Embodiments may include one of the above and/or below features, or any combination thereof. The elastic and stiff portions may both comprise plastic material. The elastic and stiff portions may be unitary. The elastic and stiff portions may be fabricated by insert molding. The elastic and stiff portions may be fabricated by two-shot molding. The elastic portion may comprise an elastomeric material, which may be a silicone material. The elastic portion may have a hardness in the range from 10 Shore A to 80 Shore A. The stiff portion may comprise a glass-filled nylon material. The elastic portion may be further constructed and arranged to create a first seal with the plunger and a second seal with the housing, wherein the first and second seals are both water resistant.

In another aspect, a unitary structure for interfacing a plunger that is exposed outside of a housing and is constructed and arranged to be pushed in relative to the housing so as to operate a switch that is located inside of the housing, wherein the plunger comprises a recess, includes an elastic portion comprising an elastomeric material and that is constructed and arranged to interface with the plunger so as to maintain the plunger in the housing and create a water-resistant seal to the plunger, wherein the elastic portion is in part located in the recess of the plunger and a stiff portion comprising a plastic material and that is coupled to the elastic portion and is constructed and arranged to interface with the housing so as to capture the structure in the housing, wherein the stiff portion comprises a frame with a top face, an inner perimeter, and a depth. The elastic portion comprises a face portion that overlies the top face of the frame, and an inner portion that abuts the inner perimeter of the frame, wherein the elastic portion creates a water-resistant seal to the housing.

In another aspect, a unitary structure for interfacing a plunger that is exposed outside of a housing and is constructed and arranged to be pushed in relative to the housing so as to operate a switch that is located inside of the housing, wherein the housing comprises a pocket with opposed sidewalls and a sealing surface, and the plunger comprises a circumferential groove, includes an elastic portion comprising an elastomeric material and that is constructed and arranged to interface with the plunger so as to maintain the plunger in the housing, wherein the elastic portion comprises a ring that is seated in the groove of the plunger and a face that is face sealed against the sealing surface of the pocket and a stiff portion comprising a plastic material and that is coupled to the elastic portion and is constructed and arranged to fit into the pocket of the housing so as to capture the structure in the housing, wherein the stiff portion comprises a frame with a top face, an inner perimeter, and a depth. The elastic portion further comprises a face portion that overlies the top face of the frame, and an inner portion that abuts the inner perimeter of the frame and has a depth that is less than the depth of the frame, wherein the inner portion of the elastic portion defines a bore and the plunger passes through the bore, and wherein the elastic portion creates a water-resistant seal to the plunger and to the housing.

### BRIEF DESCRIPTION OF THE DRAWINGS

FIG. 1 is a partial view of a housing with a switch that is operated by a plunger, where a plunger interface structure is located in the housing.

FIG. 2 shows the pocket that receives the plunger interface structure.

FIG. 3 shows the plunger.

FIGS. 4A and 4B are front and rear views, respectively, of the structure for interfacing the plunger.

FIG. 5 is a top perspective view of the stiff portion of the structure of FIGS. 4A and 4B.

FIG. 6 is a rear perspective view of the elastic portion of the structure of FIGS. 4A and 4B.

FIG. 7 is a cross-sectional view taken along line 7-7, FIG. 1

### DETAILED DESCRIPTION

The present structure interfaces a plunger that is exposed outside of a housing and is constructed and arranged to be pushed in relative to the housing so as to operate a switch that is located inside of the housing. The structure includes an elastic portion that interfaces with the plunger so as to maintain the plunger in the housing without substantially altering the force required to move the plunger. The structure also includes a stiff portion that is coupled to the elastic portion and interfaces with the housing so as to capture the structure in the housing. The elastic portion also preferably provides a moisture and dust resistant seal to both the plunger and the housing, to inhibit the ingress of dust and moisture contamination into the housing through the opening for the plunger. A unitary structure can be made by insert molding or two-shot molding, for example.

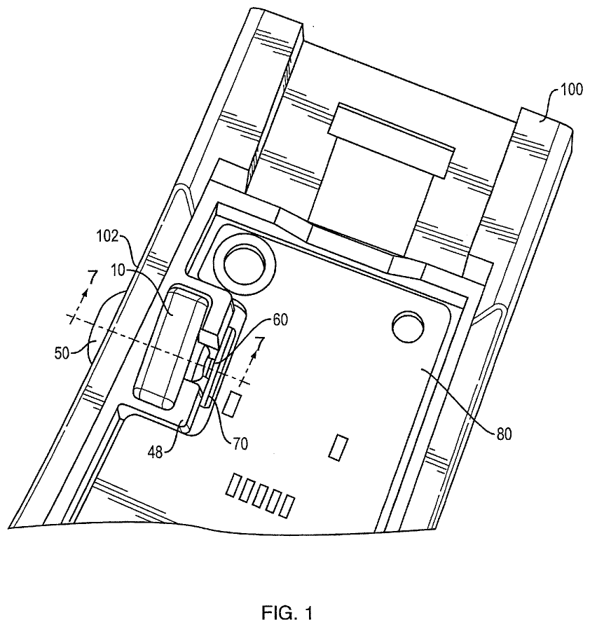

FIG. 1 is a partial view of one non-limiting use of the structure of this disclosure. Structure 10 interfaces plunger 50 to housing 100 with housing outer surface 102. In this non-limiting example, housing 100 is part of the temple of an eyeglass headphone that is designed to be worn like eyeglasses and has electro-acoustic transducers (not shown) that are arranged to provide sound to the ears. Aspects and implementations described herein may be applicable to a wide variety of devices, such as wearable audio devices in various form factors, such as headphones (whether on or off ear), headsets, watches, eyeglasses, neck-worn speakers, shoulder-worn speakers, body-worn speakers, etc. Unless specified otherwise, the term wearable audio device, as used in this document, includes headphones and various other types of personal audio devices such as head, shoulder or body-worn acoustic devices that include one or more acoustic drivers to produce sound. Some particular aspects disclosed may be particularly applicable to personal (wearable) audio devices such as in-ear headphones (also referred to as earbuds), eyeglasses or other head-mounted audio devices. Aspects and implementations described herein may also be applicable to any type of device having a user-operable switch to control functions of the device. It should be noted that although specific implementations of speaker systems primarily serving the purpose of acoustically outputting audio are presented with some degree of detail, such presentations of specific implementations are intended to facilitate understanding through provision of examples and should not be taken as limiting either the scope of disclosure or the scope of claim coverage.

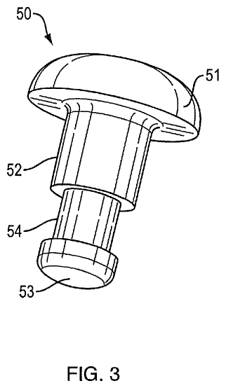

Plunger 50 may be configured to be pushed in relative to housing surface 102 such that inner end 53 (see FIG. 3) pushes in on and so operates switch 60 that is carried by mount 70, which is itself carried by printed circuit board 80 that is located inside of housing 100. Exposed surface 51 of plunger 50 (see FIG. 3) is located outside of housing 100. Switch 60 can operate in any known fashion, and can function in any desired fashion. In one non-limiting example the switch may be used to select functions of the eyeglass headphones (e.g., power on/off the eyeglass headphones, play/pause audio playback from the eyeglass headphones, change volume or modify the track being played from the eyeglass headphones, etc.).

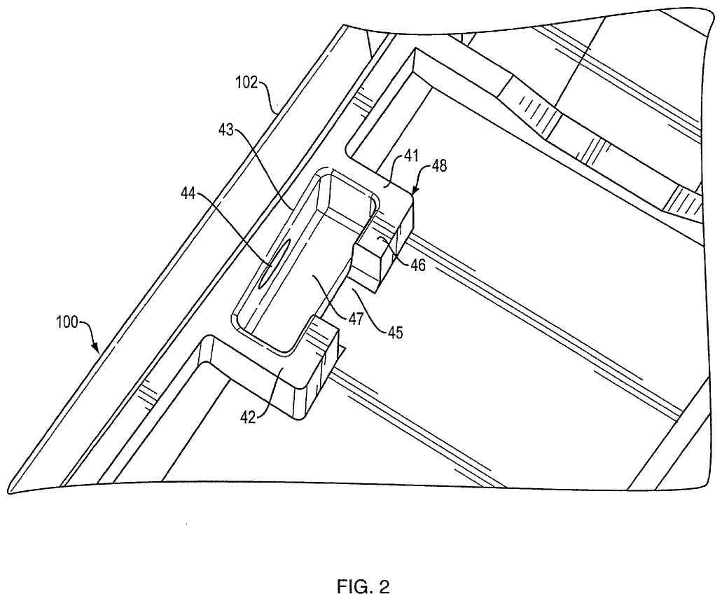

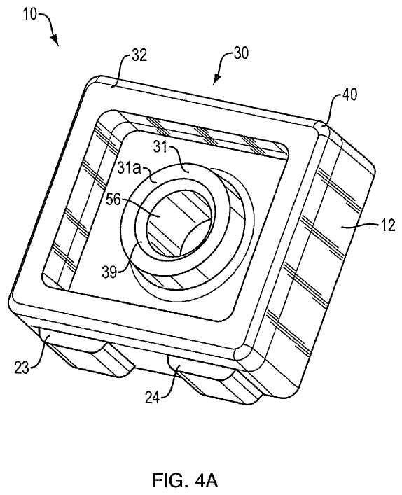

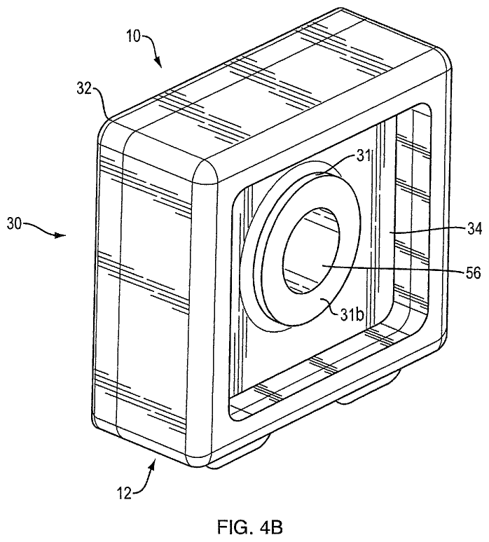

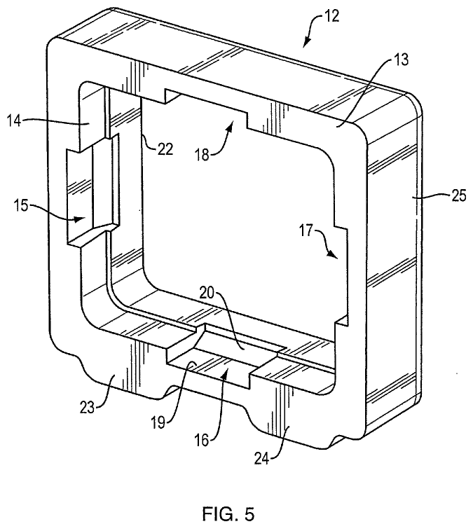

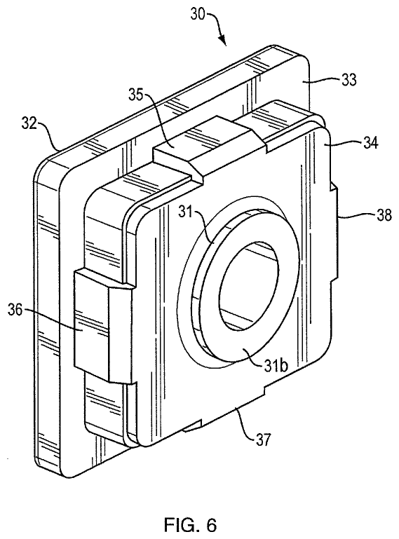

As shown in FIG. 2, housing 100 has a bore 44 through which shaft 52 of plunger 50 (see FIG. 3) passes. Since bore 44 extends to housing outer surface 102, the bore can be a point of ingress into the housing of foreign substances such as dust, water, and perspiration. Structure 10 can be constructed and arranged to seal the plunger in order to inhibit the ingress of contaminants into the housing. In one non-limiting example, this sealing is accomplished using an elastic portion 30 of structure 10. Elastic portion 30 is shown, for example, in FIGS. 4A, 4B, and 6. Elastic portion 30 can also be constructed and arranged to interface with plunger 50 so as to maintain the plunger in the housing. Structure 10 can also include a stiff portion 12 (shown, for example, in FIG. 5) that is coupled to the elastic portion and is constructed and arranged to interface with the housing so as to capture and hold the structure in the housing.

In the example detailed in the drawings, the elastic portion is constructed and arranged to create a first seal with the plunger and a separate second seal with the housing. In one non-limiting example, the first and second seals are both water resistant, and are able to meet IEC standard IPX4 (splash-proof) or IPX7 (submersible to 1 meter for 30 seconds). The use of the elastic portion to seal to both the plunger and the housing is not a requirement, as the seal could be to only one of the plunger and housing. Also, the particular results of the seal, such as resistance to contamination or liquids, is not a limitation.

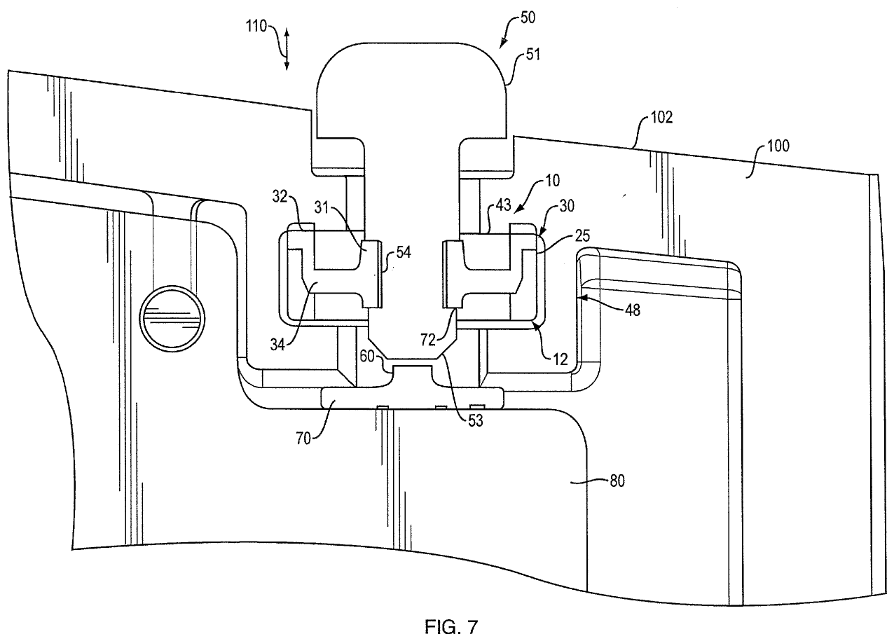

In one non-limiting example, the elastic portion can be sealed to the plunger as follows. Plunger 50 may have a recess 54, and the elastic portion may in part be located in the recess of the plunger. The recess may comprise a circumferential groove in the plunger shaft, as shown in FIG. 3. Elastic portion 30 may comprise a ring 31 that is seated in the groove. Inner portion 34 of elastic portion 30 has sufficient compliance in the direction of motion of the switch (as depicted by arrow 110, FIG. 7) to allow the plunger to move in and out without substantially altering the force that is needed to move the plunger. In order to further inhibit ring 31 from slipping out of groove 54 as the plunger moves, an adhesive 72 can be located at some or all of the interface of ring 31 and plunger 50 (i.e., between the ring and the groove).

Structure 10 can be held in the housing in any desired manner. One non-limiting example of the coupling of structure 10 to the housing is shown in the drawings. Housing 100 includes interior pocket 48, and structure 10 may be constructed and arranged to fit into the pocket. Pocket 48 is shown, for example, in FIG. 2 and may define a sealing surface 43 in the part of the housing that includes bore 44. Pocket 48 may also include sidewalls 41 and 42 and end wall 46 which defines an opening 45 for the plunger. The pocket is sized and shaped to hold structure 10 in place. Preferably but not necessarily, structure 10 stiff portion 12 also interfaces with pocket sidewalls 41 and 42. Structure 10 can be pushed into the open top of pocket 48. Standoffs 23 and 24 of portion 12 contact the bottom wall 47 of the pocket to help seat structure 10 in the pocket. The standoffs also help the person who inserts structure 10 into pocket 48 to distinguish the structure top from the bottom so that structure 10 is properly oriented in the pocket. Preferably but not necessarily, structure 10 is sealed to housing 100 by creating an interference fit between the elastic portion 30 of structure 10 and the housing. In the illustrated example, this seal is accomplished with a face seal between upper face 32 of face portion 33 of elastic portion 30 and interior sealing surface 43 of pocket 48. See FIG. 7.

Since elastic portion 30 performs one or more sealing functions, it is preferably made from a relatively soft material that can be compressed in order to facilitate the seals. In one non-limiting example the elastic portion is made from an elastomer, such as a silicone. Thermoplastic elastomers or thermoplastic urethanes may alternatively be used. The elastic portion may have a hardness in the range of 10 Shore A to 80 Shore A. Other materials and other hardnesses can be used. When structure 10 is pushed into pocket 48, face 32 will form an interference fit with sealing surface 43. Since face 32 is soft, it will deform and may be susceptible to folding or tearing as structure 10 is inserted into pocket 48. Assembly of the structure into the pocket can be facilitated by including chamfered top edge 40 of face portion 33.

Elastic portion 30 preferably also seals to the plunger as described above. The inner portion 34 of elastic portion 30 may define a bore 56. During assembly, plunger shaft 52 needs to be pushed through bore 56. Since ring 31 is arranged to sit against the surface of plunger recess 54, ring 31 has an inside diameter that is less than the outside diameter of shaft 52. Accordingly, ring 31 will be deformed when the shaft is pushed through the bore. To facilitate the insertion of the shaft, chamfer 39 can be formed along the inner edge of top face 31a of ring 31. See FIG. 4A. Ring 31 also has rear face 31b. See FIG. 4B.

Stiff portion 12, FIG. 5, may comprise a frame with a top face 13, an inner perimeter 14, and a depth between top face 13 and bottom face 22. The elastic portion face portion 33 overlies the top face 13 of the frame. Elastic portion 30 also includes an inner portion 34 that abuts the inner perimeter 14 of the frame and has a depth that is less than the depth of the frame. The inner perimeter of the frame may comprise a plurality of spaced grooves (four grooves 15-18 are illustrated, but there could be fewer or more than four). These grooves may be open to the top face 13 of the frame and have a depth less than the depth of the frame. Groove 16 is illustrative of the four identical tapered grooves, and includes flat face 19 and angled face 20. Inner portion 34 of the elastic portion 30 may comprise an equal plurality of spaced projecting portions 35-38 that fit into the spaced grooves of the frame. The taper in grooves 15-18 seats the elastic portion in the frame and helps to prevent the elastic portion from being pushed off of the frame by the downward force on the elastic portion that is created when the plunger shaft is pushed through bore 56.

The elastic and stiff portions may in one non-limiting example both comprise plastic material. The elastic and stiff portions may be coupled together such that they form a unitary construction. The elastic and stiff portions may be fabricated by insert molding. The elastic and stiff portions may alternatively be fabricated by two-shot molding. The elastic portion may comprise an elastomeric material, which may be a silicone material. The elastic portion may have a hardness in the range from 10 Shore A to 80 Shore A. The stiff portion may comprise a glass-filled nylon material, which exhibits good adhesion to silicone material and so is an appropriate stiff material that is able to create a unitary construction.

A number of implementations have been described. Nevertheless, it will be understood that additional modifications may be made without departing from the scope of the inventive concepts described herein, and, accordingly, other embodiments are within the scope of the following claims.

1. A structure for interfacing a plunger that is exposed outside of a housing and is constructed and arranged to be pushed in relative to the housing so as to operate a switch that is located inside of the housing, the structure comprising:
an elastic portion that is constructed and arranged to interface with the plunger so as to maintain the plunger in the housing; and
a stiff portion that is coupled to the elastic portion and is constructed and arranged to interface with the housing so as to capture the structure in the housing.

2. The structure of claim 1, wherein the plunger comprises a recess and the elastic portion is in part located in the recess of the plunger.

3. The structure of claim 2, wherein the recess comprises a circumferential groove in the plunger and the elastic portion comprises a ring that is seated in the groove.

4. The structure of claim 3, further comprising an adhesive substance at an interface between the ring and the groove.

5. The structure of claim 1, wherein the housing comprises a pocket and the structure is constructed and arranged to fit into the pocket.

6. The structure of claim 5, wherein the pocket defines a sealing surface and the elastic portion is face sealed against the sealing surface.

7. The structure of claim 6, wherein the pocket further defines opposed sidewalls and the stiff portion abuts the sidewalls.

8. The structure of claim 1, wherein the stiff portion comprises a frame with a top face, an inner perimeter, and a depth.

9. The structure of claim 8, wherein the elastic portion comprises a face portion that overlies the top face of the frame, and an inner portion that abuts the inner perimeter of the frame and has a depth that is less than the depth of the frame.

10. The structure of claim 9, wherein the inner perimeter of the frame comprises a plurality of spaced grooves that are open to the top face of the frame and have a depth less than the depth of the frame, and wherein the inner portion of the elastic portion comprises an equal plurality of spaced projecting portions that fit into the spaced grooves of the frame.

11. The structure of claim 9, wherein the face portion of the elastic portion has a top face with edges that are chamfered.

12. The structure of claim 9, wherein the inner portion of the elastic portion defines a bore and the plunger passes through the bore.

13. The structure of claim 12, wherein the inner portion of the elastic portion that defines the bore comprises a chamfer that abuts the plunger.

14. The structure of claim 1, wherein the elastic and stiff portions both comprise plastic material.

15. The structure of claim 1, wherein the elastic and stiff portions are unitary.

16. The structure of claim 1, wherein the elastic and stiff portions are fabricated by insert molding.

17. The structure of claim 1, wherein the elastic and stiff portions are fabricated by two-shot molding.

18. The structure of claim 1, wherein the elastic portion comprises an elastomeric material.

19. The structure of claim 18, wherein the elastomeric material comprises a silicone material.

20. The structure of claim 1, wherein the elastic portion has a hardness in the range from 10 Shore A to 80 Shore A.

21. The structure of claim 1, wherein the stiff portion comprises a glass-filled nylon material.

22. The structure of claim 1, wherein the elastic portion is further constructed and arranged to create a first seal with the plunger and a second seal with the housing, wherein the first and second seals are both water resistant.

23. A unitary structure for interfacing a plunger that is exposed outside of a housing and is constructed and arranged to be pushed in relative to the housing so as to operate a switch that is located inside of the housing, wherein the plunger comprises a recess, the structure comprising:
an elastic portion comprising an elastomeric material and that is constructed and arranged to interface with the plunger so as to maintain the plunger in the housing and create a water-resistant seal to the plunger, wherein the elastic portion is in part located in the recess of the plunger; and
a stiff portion comprising a plastic material and that is coupled to the elastic portion and is constructed and arranged to interface with the housing so as to capture the structure in the housing, wherein the stiff portion comprises a frame with a top face, an inner perimeter, and a depth;
wherein the elastic portion comprises a face portion that overlies the top face of the frame, and an inner portion that abuts the inner perimeter of the frame, and wherein the elastic portion creates a water-resistant seal to the housing.

24. A unitary structure for interfacing a plunger that is exposed outside of a housing and is constructed and arranged to be pushed in relative to the housing so as to operate a switch that is located inside of the housing, wherein the housing comprises a pocket with opposed sidewalls and a sealing surface, and the plunger comprises a circumferential groove, the structure comprising:
an elastic portion comprising an elastomeric material and that is constructed and arranged to interface with the plunger so as to maintain the plunger in the housing, wherein the elastic portion comprises a ring that is seated in the groove of the plunger and a face that is face sealed against the sealing surface of the pocket; and
a stiff portion comprising a plastic material and that is coupled to the elastic portion and is constructed and arranged to fit into the pocket of the housing so as to capture the structure in the housing, wherein the stiff portion comprises a frame with a top face, an inner perimeter, an a depth;
wherein the elastic portion further comprises a face portion that overlies the top face of the frame, and an inner portion that abuts the inner perimeter of the frame and has a depth that is less than the depth of the frame, wherein the inner portion of the elastic portion defines a bore and the plunger passes through the bore, and wherein the elastic portion creates a water-resistant seal to the plunger and to the housing.
